(19) United States
(12) Patent Application Publication
(10) Pub. No.: US 2020/0099728 A1
(43) Pub. Date: Mar. 26, 2020

(54) CONTROL APPARATUS AND NON-TRANSITORY COMPUTER READABLE MEDIUM

(71) Applicant: FUJI XEROX CO., LTD., Tokyo (JP)

(72) Inventor: Takafumi HARUTA, Kanagawa (JP)

(73) Assignee: FUJI XEROX CO., LTD., Tokyo (JP)

(21) Appl. No.: 16/569,796

(22) Filed: Sep. 13, 2019

(30) Foreign Application Priority Data
Sep. 25, 2018 (JP) 2018-179450
Sep. 25, 2018 (JP) 2018-179451

(51) Int. Cl. H04L 29/06; H04L 12/58

(52) U.S. Cl. CPC H04L 65/403; H04L 51/18

(57) ABSTRACT

There is provided a control apparatus including a processor, in which in a talk room, each of plural participating users among plural users registered for each user group is able to post information, and the processor is configured, when in the talk room, during an execution of a specific process, a second user who has been registered in a user group in which a first user is registered posts second information after the first user posts first information among a series of information related to the specific process, to process the second information as the series of information.

### CROSS-REFERENCE TO RELATED APPLICATIONS

This application is based on and claims priority under 35 USC 119 from Japanese Patent Application No. 2018-179450 and 2018-179451 both filed Sep. 25, 2018.

### BACKGROUND

### (i) Technical Field

The present disclosure relates to a control apparatus and a non-transitory computer readable medium.

### (ii) Related Art

JP-A 2014-164522 discloses a message reporting device which includes: an operation instruction detecting unit that detects an operation instruction to operate an external device from a message in a communication service for sequentially displaying messages written by a member, and simultaneously specifies the member who writes the corresponding message as an instructor of the corresponding operation instruction; an external device controller that controls the external device according to the operation instruction detected by the operation instruction detecting unit; an operation result acquiring unit that acquires a result of the operation of the external device under a control by the external device controller; a report message generating unit that generates a report message for reporting the operation result acquired by the operation result acquiring unit; and a report message displaying unit that outputs the report message generated by the report message generating unit to a server for providing the communication service, and causes the communication service to display the corresponding message in a state where the instructor specified by the operation instruction detecting unit is indicated as an addressee.

### SUMMARY

A chatbot which is an automatic conversation program has been known in recent years. The chatbot automatically posts messages in response to a user posting a message (a user chatting) in a talk room. As a further use example, the chatbot executes a process based on information such as messages posted by a user.

Here, it is assumed that a single process is executed based on a series of information posted in a talk room in which plural users participate. In this case, an operation which does not follow the intention of a user may be performed according to a way of executing a process.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a control apparatus including a processor, in which in a talk room, each of plural participating users among plural users registered for each user group is able to post information, and the processor is configured, when in the talk room, during an execution of a specific process, a second user who has been registered in a user group in which a first user is registered posts second information after the first user posts first information among a series of information related to the specific process, to process the second information as the series of information.

### BRIEF DESCRIPTION OF THE DRAWINGS

Exemplary embodiment(s) of the present disclosure will be described in detail based on the following figures, wherein:

FIG. 1 is a view illustrating a schematic configuration of a control system according to an exemplary embodiment of the present disclosure;

FIG. 2 is a block diagram illustrating a hardware configuration of a talk room server;

FIG. 3 is a block diagram illustrating a hardware configuration of a chatbot server;

FIG. 4 is a block diagram illustrating an example of a functional configuration of the talk room server;

FIG. 5 is a block diagram illustrating an example of a functional configuration of the chatbot server;

FIG. 6 is an example of a table representing a correspondence relationship between users and image forming apparatuses which is registered in a registration unit;

FIG. 7 is an example of a table representing a correspondence relationship among talk rooms, users, and image forming apparatuses which is registered in the registration unit;

FIG. 8 is a view illustrating an example of a flow of a printing process according to the exemplary embodiment of the present disclosure;

FIG. 9 is a flowchart of a control process by the chatbot server;

FIG. 10 is a flowchart of a message information classification process;

FIG. 11 is a view illustrating a process transition according to postings by plural users;

FIG. 12 is a view illustrating a process transition according to postings by plural users;

FIG. 13 is a view illustrating a process transition according to postings by plural users;

FIG. 14 is a view illustrating a process transition according to postings by plural users;

FIG. 15 is a view illustrating a process transition according to postings by plural users;

FIG. 16 is a view illustrating a process transition according to postings by plural users;

FIG. 17 is a view illustrating a state in which postings are made in a talk room;

FIG. 18 is a view illustrating a state in which postings are made in the talk room;

FIG. 19 is a view illustrating a state in which postings are made in the talk room;

FIG. 20 is an example of a table representing a correspondence relationship among talk rooms, users, and image forming apparatuses which is registered in the registration unit;

FIG. 21 is a flowchart of a control process by the chatbot server;

FIG. 22 is a flowchart of a permission process;

FIG. 23 is a view illustrating a state where postings are made in the talk room;

FIG. 24 is a view illustrating a state where postings are made in the talk room;

FIG. 25 is a view illustrating a state where postings are made in the talk room;

FIG. 26 is a flowchart of a setting process by the chatbot server;

FIGS. 27A to 27C are views illustrating states where postings are made in the talk room;

FIG. 28 is a flowchart of an acquisition process by the chatbot server;

FIG. 29 is a view illustrating a state where postings are made in the talk room;

FIG. 30 is a view illustrating a state where postings are made in the talk room;

FIG. 31 is a flowchart of a confirmation process by the chatbot server; and

FIG. 32 is a view illustrating a state where postings are made in the talk room.

### DETAILED DESCRIPTION

Hereinafter, exemplary embodiments for implementing the technology of the present disclosure will be described with reference to the accompanying drawings.

In addition, in the respective drawings, identical or equivalent components and portions will be denoted by the same reference numerals. In addition, since the dimensional ratio of each drawing is represented in an exaggerated manner for the convenience of descriptions, the dimensional ratio of each drawing may be different from an actual ratio.

### First Exemplary Embodiment

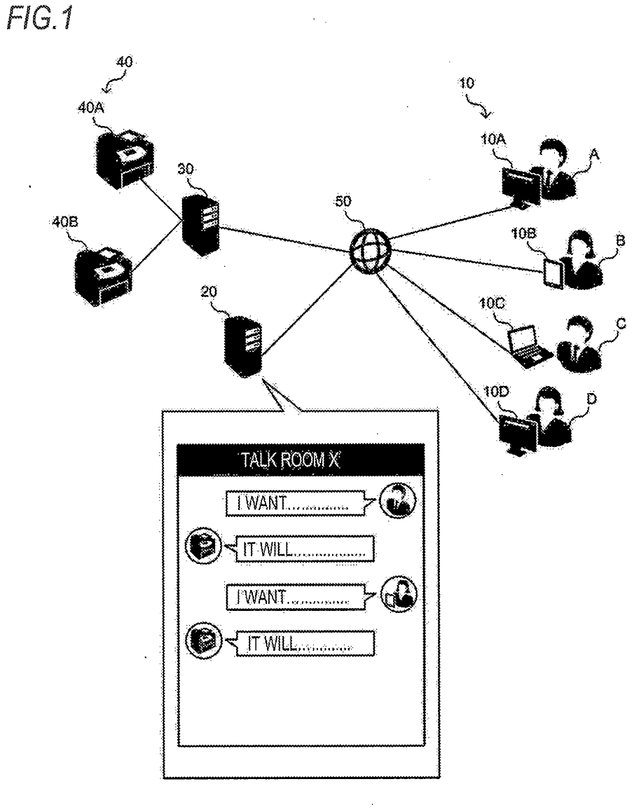

FIG. 1 is a view illustrating a schematic configuration of a control system according to a first exemplary embodiment of the present disclosure.

The control system includes a user terminal 10, a talk room server 20, a chatbot server 30 which serves as a processor of the present disclosure, and an information processing apparatus 40. The user terminal 10, the talk room server 20, and the chatbot server 30 (an example of a control apparatus) are connected to each other via the Internet 50.

The user terminal 10 is a terminal used by a user. The user terminal 10 may be any terminal such as a desktop computer, a laptop computer, a tablet, or a smartphone. In FIG. 1, it is assumed that a user A uses a user terminal 10A, a user B uses a user terminal 10B, a user C uses a user terminal 10C, and a user D uses a user terminal 10D. The user terminals 10A to 10D may be collectively referred to as a user terminal 10.

The talk room server 20 provides a talk room. The talk room is a virtual space in which users and a chatbot (which will be described later) participate to be able to share data such as messages and images (hereinafter, referred to as “message information”) though chatting. Here, the chatting refers to making a conversation in a manner that plural members input information in real time on a computer network. Here, the members include both users associated with real persons and a software robot that operates according to specific rules. In addition, the chatbot is a software robot that performs control so as to execute a specific process based on information posted by a user in the talk room.

A user is able to post or speak message information in the talk room through the user terminal 10. In the talk room, users are able to share message information, and further, the chatbot may, for example, respond to message information of a user. Further, in the talk room, a user may give an instruction to the chatbot, to cause the information processing apparatus 40 to execute a specific process. The chatbot extracts an instruction included in message information by, for example, a natural language processing, so as to control the information processing apparatus 40 to execute the specific process. Further, a single user and a single chatbot may participate in a talk room, or plural users and a chatbot may participate in the talk room. Plural talk rooms may exist as many as the number of talk rooms created.

The chatbot server 30 is a server that manages the chatbot. As described above, the chatbot participates in the talk room and responds to message information of a user or causes the information processing apparatus 40 to execute a specific process according to an instruction included in message information.

For example, when message information related to an instruction to cause the information processing apparatus 40 to execute a specific process is posted in the talk room in which the chatbot participates, the chatbot controls the information processing apparatus 40 that is registered in association with the user who participates in the talk room, to execute a specific process. The information processing apparatus 40 may be an information processing apparatus that executes any information processing. Here, examples of the information processing include a process of executing printing based on character data or image data, a process of generating or processing data using equipment provided in the information processing apparatus 40, and a process of exchanging data between the information processing apparatus 40 and another apparatus.

In the following description, an example where the information processing apparatus 40 is an image forming apparatus, and the instruction to execute the specific process is an instruction to execute printing will be described. Further, hereinafter, the image forming apparatus will be denoted by the reference numeral 40. The instruction to execute printing includes not only a direct printing instruction to the image forming apparatus 40 but also providing information necessary to generate a print job (for example, image data to be printed or printing specification), in the talk room. That is, when information related to the printing to be executed by the image forming apparatus 40 is posted in the talk room in which the chatbot participates, the chatbot performs control so as to proceed with the process related to the printing according to the posted information. The instruction to execute the printing is an example of providing a series of information related to a specific process. The chatbot performs each control so as to cause the image forming apparatus 40 to execute the printing, according to a posting of each of the series of information related to the printing.

FIG. 8 is a view illustrating an example of a process transition with regard to posting of information related to the printing, as an example of providing a series of information related to a specific process. Providing a series of information as illustrated in FIG. 8 corresponds to an instruction to execute printing, that is, posting of information.

Specifically, first, a user posts message information indicating a printing instruction in the talk room (process P01). In response, the chatbot posts message information indicating a request for posting of a file (process P02). Next, in response to the request for posting of a file, the user posts message information indicating a printing target file (process P03). In response to the posting of the file, the chatbot posts message information for requesting a printing setting indicating how the posted file is to be printed (process P04). Then, the user posts information indicating the printing setting (process P05). In response, the chatbot outputs information to the image forming apparatus 40 such that it is started to print the printing target file according to the posted printing setting (process P06). While FIG. 8 represents an example where the printing process is triggered by the process P01 in which the message information indicating the printing instruction is posted, the printing process may be triggered by the process P03 in which the user posts the message information indicating the printing target file. In this case, the process may be proceeded with while the processes P01 and P02 being regarded as having been executed as a result of the posting in the process P03.

The image forming apparatus 40 is an apparatus that forms an image on a recording medium such as a sheet of paper, based on the print job. The image forming apparatus 40 may be any apparatus such as a printer or a multifunctional machine. In the example of the control system of FIG. 1, the image forming apparatuses 40A and 40B are managed by the chatbot server 30. The image forming apparatuses 40A and 40B will be collectively referred to as the image forming apparatus 40. In the illustrated example, the image forming apparatus 40 is connected to the chatbot server 30. Alternatively, the image forming apparatus 40 may be connected to the chatbot server 30 via the Internet 50.

Next, a hardware configuration of each of the talk room server 20 and the chatbot server 30 will be described.

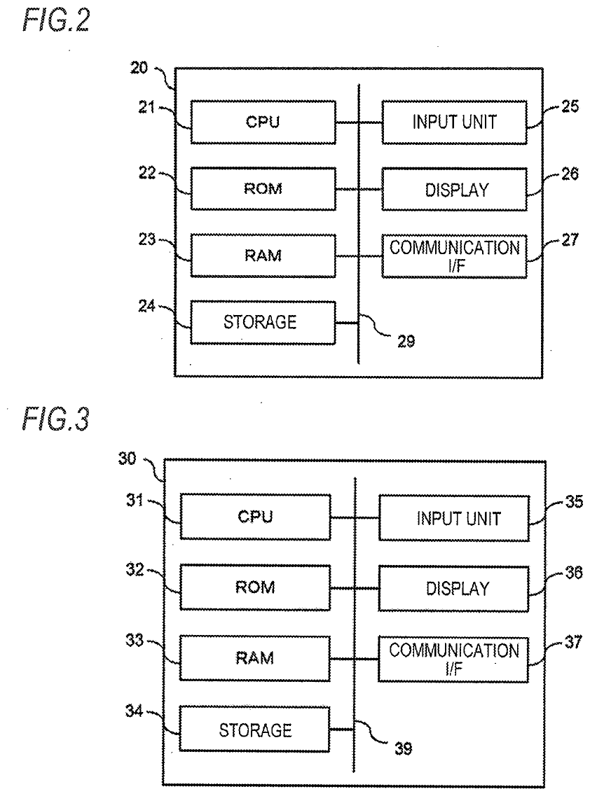

FIG. 2 is a block diagram illustrating the hardware configuration of the talk room server.

As illustrated in FIG. 2, the talk room server 20 includes a central processing unit (CPU) 21, a read only memory (ROM) 22, a random access memory (RAM) 23, a storage 24, an input unit 25, a display 26, and a communication interface 27. The respective components are connected to each other via a bus 29 so as to be able to communicate with each other.

The CPU 21 is a central arithmetic processing unit, and executes various programs or controls the respective components. That is, the CPU 21 reads a program from the ROM 22 or the storage 24, and executes the program by using the RAM 23 as a work area. The CPU 21 controls the respective components described above and performs various kinds of arithmetic processing according to the program recorded in the ROM 22 or the storage 24. In the first exemplary embodiment, a talk room providing program for providing a talk room is stored in the ROM 22 or the storage 24.

The ROM 22 stores various programs and various data. The RAM 23 which serves as a work area temporarily stores programs or data. The storage 24 is implemented by a hard disk drive (HDD) or a solid state drive (SSD). The storage 24 stores various programs including an operating system and various data.

The input unit 25 includes a pointing device such as a mouse, and a keyboard. The input unit 25 is used for performing various inputs. The display 26 is, for example, a liquid crystal display, and displays various kinds of information. The display 26 may adopt a touch panel system, so as to function as the input unit 25. The communication interface 27 is an interface for communicating with another apparatus via the Internet 50. The communication interface 27 may comply with standards such as Ethernet (registered trademark), FDDI, and Wi-Fi (registered trademark).

FIG. 3 is a block diagram illustrating the hardware configuration of the chatbot server.

As illustrated in FIG. 3, the chatbot server 30 includes a CPU 31, a ROM 32, a RAM 33, a storage 34, an input unit 35, a display 36, and a communication interface 37. The respective components are connected to each other via a bus 39 so as to be able to communicate with each other. The respective components of the chatbot server 30 have the same functions as those of the respective components of the talk room server 20 of FIG. 2.

Next, a functional configuration of each of the talk room server 20 and the chatbot server 30 will be described.

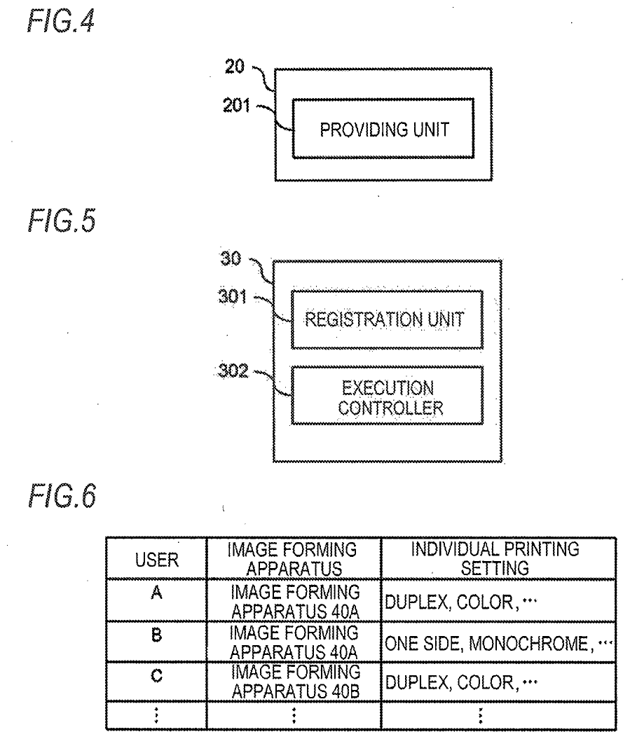

FIG. 4 is a block diagram illustrating an example of the functional configuration of the talk room server.

As illustrated in FIG. 4, the talk room server 20 includes a providing unit 201 as a functional configuration. The functional configuration is implemented by the CPU 21 reading a talk room providing program that is stored in the ROM 22 or the storage 24 and deploying and executing the program on the RAM 23.

The providing unit 201 provides a talk room in which plural users are able to participate and post messages. The talk room server 20 provides, for example, a talk room in which a single user and a single chatbot participate and a talk room in which plural users and a chatbot participate. Plural talk rooms may be created according to creation requests from users. In addition, for example, when a specific user accesses to the talk room server 20 to request for creation of a talk room and a specific talk room is created, the user who is the talk room creating person may invite another user to join the created talk room. Alternatively, when a user has already participated in the talk room, the user who is the talk room creating person may invite another user who does not participate in the talk room to newly join the talk room.

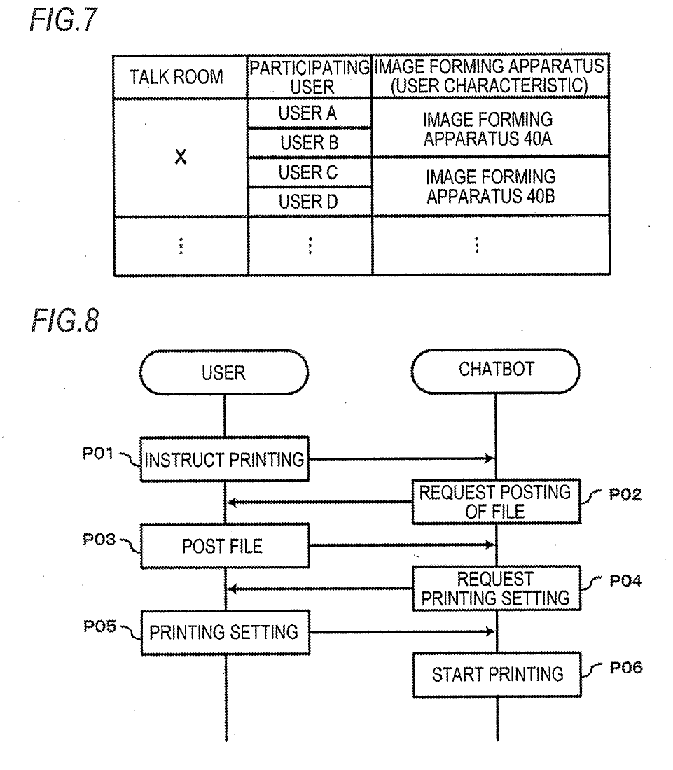

FIG. 5 is a block diagram illustrating an example of the functional configuration of the chatbot server. FIG. 6 is an example of a table representing a correspondence relationship between users and image forming apparatuses which is registered in a registration unit. FIG. 7 is an example of a table representing a correspondence relationship among talk rooms, users, and image forming apparatuses which is registered in the registration unit.

As illustrated in FIG. 5, the chatbot server 30 includes a registration unit 301 and an execution controller 302 as functional configurations. Each functional configuration is implemented by the CPU 31 reading a control program stored in the ROM 32 or the storage 34 and deploying and executing the program on the RAM 33.

For example, as illustrated in FIG. 6, the registration unit 301 registers a user and an image forming apparatus in association with each other. In the example illustrated in FIG. 6, each user may be further associated with a basic printing setting which is required to instruct printing. In addition, for example, as illustrated in FIG. 7, the registration unit 301 registers a talk room and an image forming apparatus(es) in association with each other. In the example illustrated in FIG. 7, each talk room is further associated with user characteristics. The user characteristic is information in which a registered user and an image forming apparatus are associated with each other. That is, the user characteristic indicates which image forming apparatus a registered user registers for printing.

The table illustrated in FIG. 6 is provided to register a setting when a single user and a single chatbot participate in a talk room, that is, when a user makes an instruction to an image forming apparatus which is mainly used by the user. The table illustrated in FIG. 6 is registered in advance by each user. Meanwhile, the table illustrated in FIG. 7 is provided when plural users participate in a talk room, that is, when the talk room is shared. In the table illustrated in FIG. 7, each talk room is associated with users who are participating in the talk room. Furthermore, each user in the talk room is associated with an image forming apparatus as a user characteristic. When a user joins a talk room, an image forming apparatus 40 which is associated with the user in the table illustrated in FIG. 6 is registered as a user characteristic in association with the talk room, so that the table illustrated in FIG. 7 is formed.

The execution controller 302, as the chatbot, participates in the talk room. Then, when a user posts information, such as a message and an image, related to printing by the image forming apparatus (information processing apparatus) 40 in the talk room, the execution controller 302 performs a control so as to execute the printing based on the user characteristic associated with the user who participates in the talk room.

Next, an operation of the chatbot server 30 will be described. Here, it is assumed that in order to execute the printing, a series of information is provided according to a printing instruction process illustrated in FIG. 8, that is, message information is posted as an instruction to execute the printing.

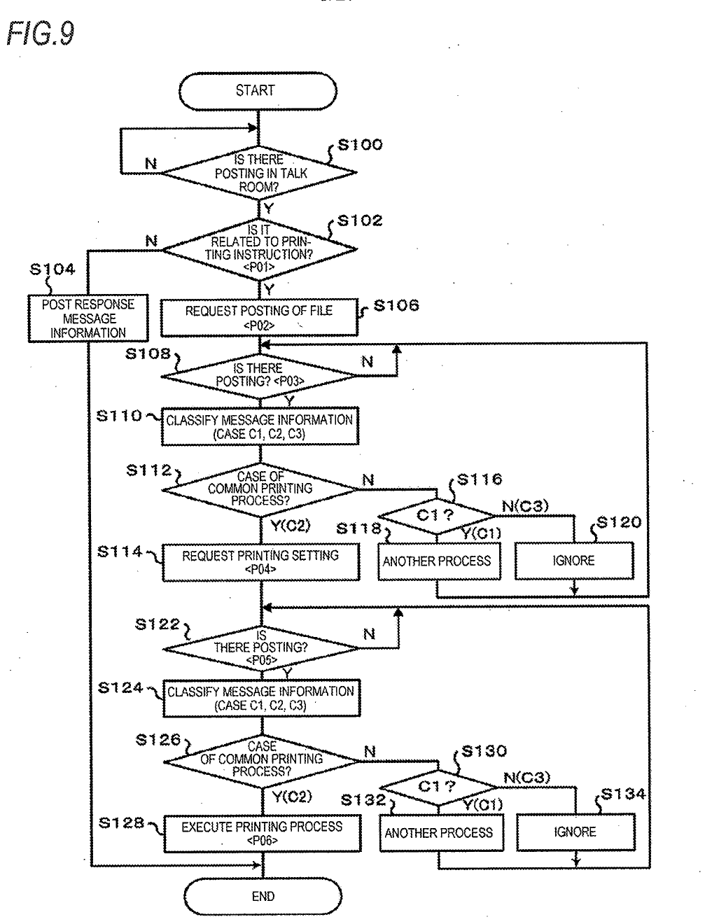

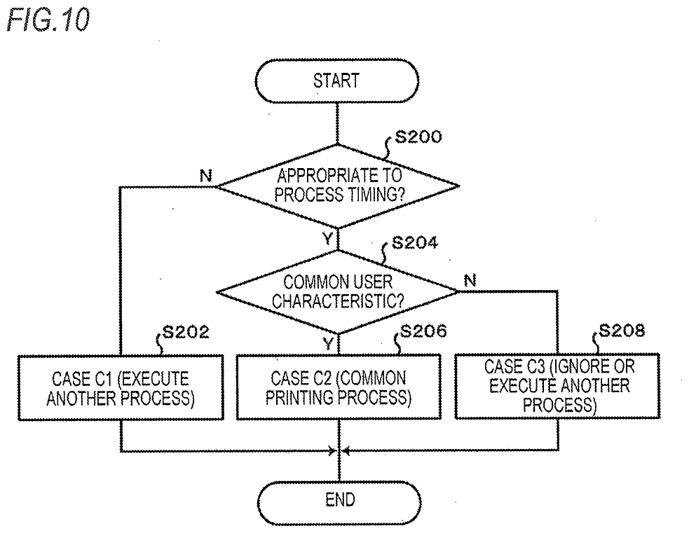

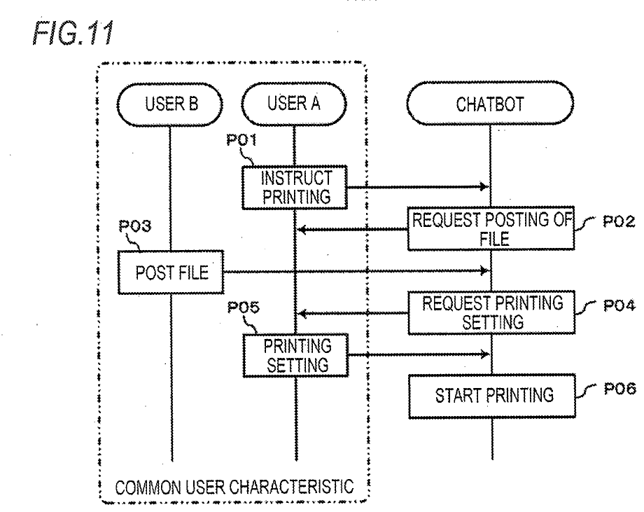

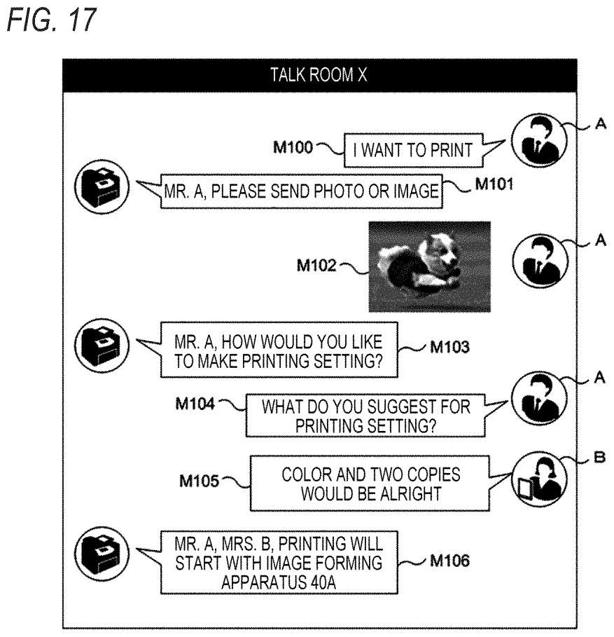

FIG. 9 is a flowchart of a control process by the chatbot server. The control process is performed by the CPU 31 reading a control program from the ROM 32 or the storage 34, and deploying and executing the control program on the RAM 33. FIG. 10 is a flowchart of a message information classification process illustrated in step S110 of FIG. 9. FIGS. 11 to 16 are views illustrating process transitions according to postings by plural users. FIGS. 17 to 19 are views illustrating posting situations in a talk room.

The CPU 31 which serves as the execution controller 302 determines whether message information has been posted by a user in the talk room (step S100). When it is determined that no message information has been posted in the talk room (“No” in step S100), the CPU 31 waits until message information is posted. When it is determined that message information has been posted in the talk room (“Yes” in step S100), the CPU 31 determines whether the posted message information is a message related to a printing instruction (step S102). Here, the CPU 31 analyzes the posted message information by, for example, the natural language processing, and when the posted message information includes “print” or words related to a printing setting, the CPU 31 determines that the posted message information is message information related to a printing instruction.

When it is determined that the posted message information is not related to a printing instruction (“No” in step S102), the CPU 31 posts response message information which is appropriate to the posted message information, in the talk room (step S104). For example, when the user posts a message asking about the weather as message information, the CPU 31, as the chatbot, acquires weather information from the Internet and posts a message for answering the weather as response message information in the talk room. Accordingly, a conversation between the user and the chatbot is established in the talk room.

When it is determined that the posted message information is related to a printing instruction (“Yes” in step S102), the CPU 31 posts message information indicating a request for posting of a file which is printing target data (step S106). Next, the CPU 31 determines whether message information is posted by the user in response to step S106 in the talk room (step S108). Here, the message information to be posted is message information indicating a file including printing target data. When it is determined that no message information is posted in the talk room (“No” in step S108), the CPU 31 waits until message information is posted. When it is determined that message information is posted in the talk room (“Yes” in step S108), the CPU 31 executes a process of classifying a response to the posted message information (step S110). This process is a process of classifying the posted message information into a corresponding printing process, and hereinafter, will be referred to as a message information classification process. The CPU 31 processes the printing process according to a determination result of the message information classification process.

Here, the message information classification process in step S110 will be described.

FIG. 10 is a flowchart of the message information classification process.

The CPU 31 determines whether a process timing of the message information posted by the user in the talk room is appropriate to the current process timing (step S200). When it is determined that the process timing of the posted message information is not appropriate to the current process timing (“No” in step S200), the CPU 31 classifies the posted message information into a case C1 indicating execution of a process related to another printing (step S202). The phrase “a process timing is appropriate” refers to that message information is posted at a timing expected by the chatbot and the content of the message information is appropriate. Here, when message information is posted at a timing at which the message information of the process P03 which is a response to the process P02 is to be posted and when the content of the message information is appropriate to the content of the message information of the process P03, “the process timing is appropriate”. For example, when the posted message information is analyzed and the posted message information includes a file including data such as image data and document data which may be used as a printing target, it is determined that the process timing of the posted message information is appropriate.

Meanwhile, when it is determined that the process timing is appropriate (“Yes” in step S200), the CPU 31 refers to the table illustrated in FIG. 7, and determines whether the user characteristic of the user who has posted the message information in the process P03 is common to the user characteristic of the user who has posted the message information in the process P01 (step S204). That is, it is determined whether the user characteristic of the user who has posted the file expected by the chatbot is common to the user characteristic of the user who has instructed the printing. When it is determined that the user characteristics are common to each other (“Yes” in step S204), the CPU 31 classifies the posted message information into a case C2 indicating that a common printing process is executable (step S206). For example, when the user A posts a message related to a printing instruction and the user B posts a file in response, the CPU 31 classifies the message information into the case C2 because the user characteristics are common to each other as illustrated in FIG. 7.

When it is determined that the user characteristics are different from each other (“No” in step S204), the CPU 31 classifies the posted message information into a case C3 (step S208). Message information which is not appropriate in process timing and has a different user characteristic is considered not to request execution of a common printing process. The process on the message information classified into the case C3 corresponds to ignoring the message information or executing another printing process. In order to set ignoring or execution of another printing process, a setting condition may be determined in advance. For example, when an operation condition is determined in advance that defines the number of image forming apparatuses 40 allowed to operate simultaneously for the purpose of the power saving or the reduction of power consumption of the control system, a printing instruction to image forming apparatuses 40 the number of which exceeds the number of apparatuses defined in the operation condition is ignored. Meanwhile, when message information indicates a printing instruction to image forming apparatuses 40 the number of which falls within the number of apparatuses defined in the operation condition, execution of another printing process may be instructed.

In this way, for the message information classified into any of the cases C1 to C3, the CPU 31 executes a corresponding process in processes after step S112 illustrated in FIG. 9.

Specifically, the CPU 31 determines whether the message information is classified into the case C2, to thereby determine whether the message information is classified into message information for the common printing process (step S112). When it is determined that the message information is classified into the case C2 (“Yes” in step S112), the CPU 31 posts message information indicating a request for a printing setting, as a subsequent process P04 (step S114).

A process transition according to postings by plural users A and B having the common user characteristic will be described. As illustrated in FIG. 11, postings of message information by the users A and B having the common user characteristic are treated as equivalents. In the example illustrated in FIG. 11, the CPU 31 classifies the posted message information into the case C2, and posts the message information indicating a request for a printing setting, as the subsequent process P04.

When the message information is classified into a case other than the case C2 (“No” in step S112 illustrated in FIG. 9), the CPU 31 determines whether the message information is classified into the case C1 (step S116). When it is determined that the message information is classified into the case C1 (“Yes” in step S116), the CPU 31 starts another process according to the message information, and waits until message information of the process P03 is posted (step S108).

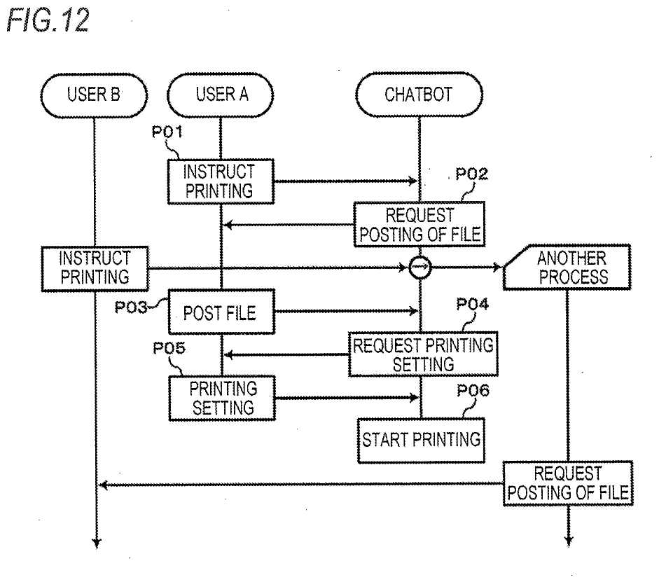

A process transition according to postings by plural users which are appropriate in process timing will be described. As illustrated in FIG. 12, at the process timing after the chatbot posts the message information indicating a request for posting of a file (process P02), the chatbot expects posting of a file from the user. When the user B posts message information indicating a printing instruction in the talk room at this process timing, the message information is not considered as message information indicating posting of a file expected by the chatbot but is considered as the intention of the user B to newly instruct a printing. In the example illustrated in FIG. 12, the CPU 31 classifies the posted message information into the case C1, and executes a process related to another printing.

When the message information is classified into the case C3 (“No” in step S116), the CPU 31 ignores the message information, and waits until message information of the process P03 is posted (step S108). Here, the description has been given on the example in which it is determined in advance that the process on the message information classified into the case C3 is to ignore the message information.

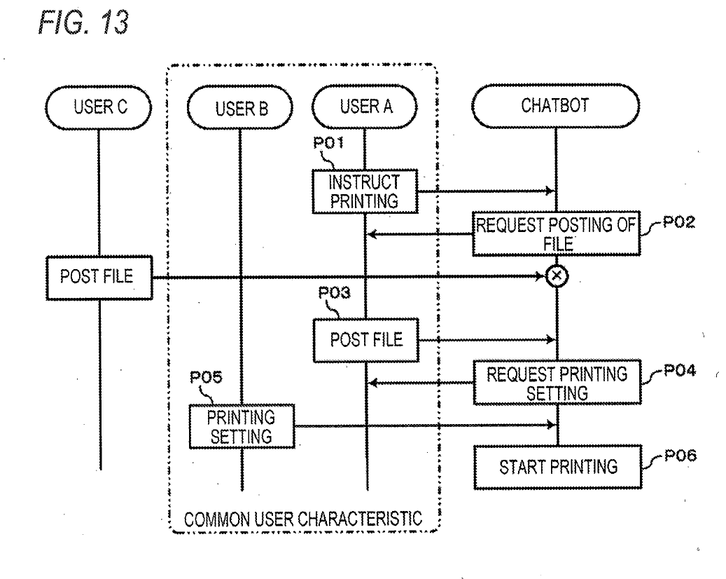

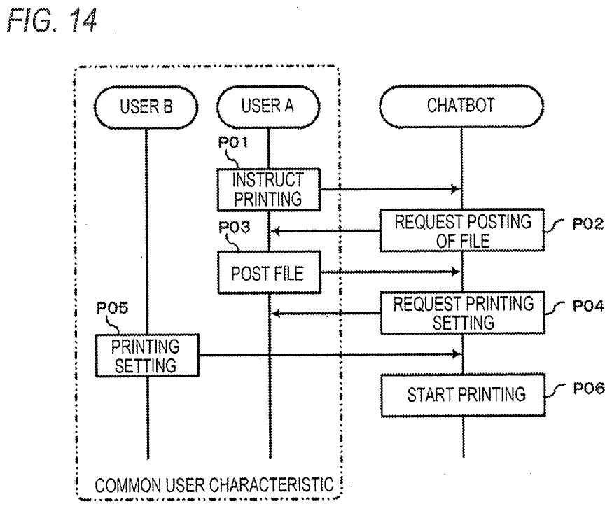

A process transition according to postings by plural users which are not appropriate in process timing and which are different from each other in user characteristic will be described. As illustrated in FIG. 13, when the user C having a different user characteristic from that of the user A posts message information indicating a file in the talk room at the process timing after the chatbot posts the message information indicating a request for posting of a file (process P02), the CPU 31 classifies the message information into the case C3, ignores the message information, and waits until message information of the process P03 is posted.

Next, after the posting of the message information in the process P04, the CPU 31 determines whether message information has been posted by a user in the talk room (step S122 illustrated in FIG. 9). When it is determined that no message information has been posted in the talk room (“No” in step S122), the CPU 31 waits until message information is posted. When it is determined that message information has been posted in the talk room (“Yes” in step S122), the CPU 31 executes the process of classifying a response to the posted message information as in step S110 (step S124). For the message information classified into any one of the cases C1 to C3, the CPU 31 executes a corresponding process in processes after step S126, as in steps S112 to S120.

Specifically, as in step S112, the CPU 31 determines whether the message information is classified into message information for the common printing process (step S126). When it is determined that the message information is classified into the case C2 (“Yes” in step S126), the CPU 31 posts message information indicating execution of the printing process as a subsequent process P06 (step S128). Further, in order to cause the image forming apparatus 40 to execute the printing process, the CPU 31 outputs the posted printing setting and printing target file. Accordingly, the printing process is executed. When the message information is classified into the case C1 (“No” in step S126 and “Yes” in step S130), the CPU 31 starts another process according to the message information, and waits until message information of the process P05 is posted (step S122). When the message information is classified into the case C3 (“No” in step S126 and “No” in step S130), the CPU 31 ignores the message information and waits until message information of the process P05 is posted (step S122).

A process transition according to postings by plural users when message information is classified into the case C2 will be described. As illustrated in FIG. 14, postings of message information by the users A and B having the common user characteristic are treated as equivalents. The CPU 31 classifies message information posted by the user B which indicates a printing setting into the case C2, receives the message information by the user B as the message information posted by the user A, and starts the printing process as the subsequent process P06.

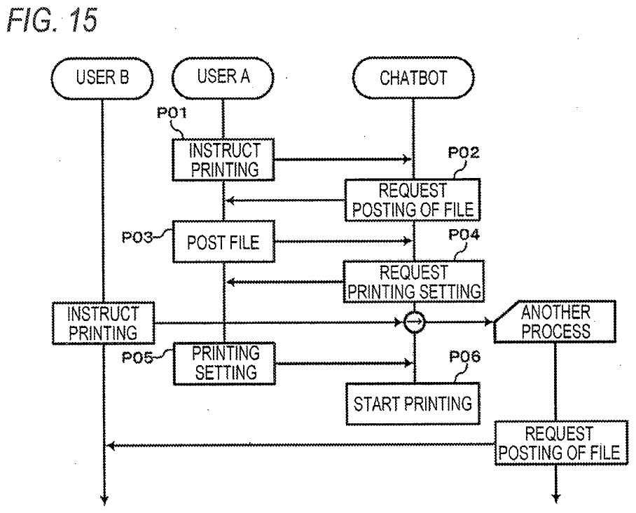

As illustrated in FIG. 15, at the process timing after the chatbot posts the message information indicating a request for a printing setting (process P04), the chatbot expects posting of message information indicating a printing setting from a user. When the user B posts message information indicating a printing instruction in the talk room at this process timing, the message information is not considered as message information indicating posting of a file expected by the chatbot but is considered as the intention of the user B to newly instruct a printing. In the example illustrated in FIG. 15, the CPU 31 classifies the posted message information into the case C1, and executes a process related to another printing.

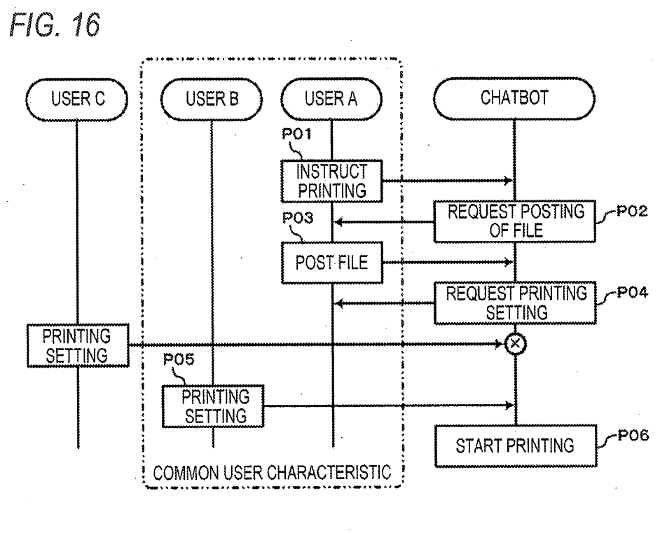

Further, as illustrated in FIG. 16, when the user C having a different user characteristic from that of the user A posts message information indicating a file in the talk room at the process timing after the chatbot posts the message information indicating a request for a printing setting (process P04), the CPU 31 classifies the message information into the case C3, ignores the message information, and waits until message information of the process P05 is posted.

Next, descriptions will be made on a posting situation in the talk room processed according to the classification of message information.

FIG. 17 is an example of a case where with respect to message information posted at the process timing after the process P04, message information from the user B having a common user characteristic to the user A who has instructed printing is treated as being common to message information of the user A.

As illustrated in FIG. 17, when message information M100 related to a printing instruction is posted by the user A in the talk room (process P01), the CPU 31 posts message information M101 indicating a request for posting of a file (process P02). In response, the user A posts message information M102 indicating a file including printing target data (process P03). In response to the posting of the message information M102, the CPU 31 posts message information M103 indicating a request for a printing setting (process P04). In response to the posting of the message information M103, the user posts message information M104 and M105 indicating the printing setting (process P05). In response to the postings of message information M104 and M105, the CPU 31 posts message information M106 indicating start of the printing (process P06).

In the example illustrated in FIG. 17, in response to the posting of the message information M103, the message information M104 inquiring the other users about the printing setting is posted. In response to the posting of the message information M104 indicating the inquiry, the user B posts the message information M105 indicating confirmation of the printing setting. The CPU 31 analyzes the posted message information M105 by, for example, the natural language processing, and determines that the message information M105 is message information related to a printing setting, when the message information M105 includes words related to a printing setting such as “color” or “two copies”. Further, the CPU 31 refers to the table illustrated in FIG. 7, and determines whether the user characteristic of the user B who has posted the message information M105 is common to the user characteristic of the user A who has posted the message information M100. In the example illustrated in FIG. 17, the CPU 31 classifies the message information M105 into the case C2, and posts the message information M106 indicating the start of the printing.

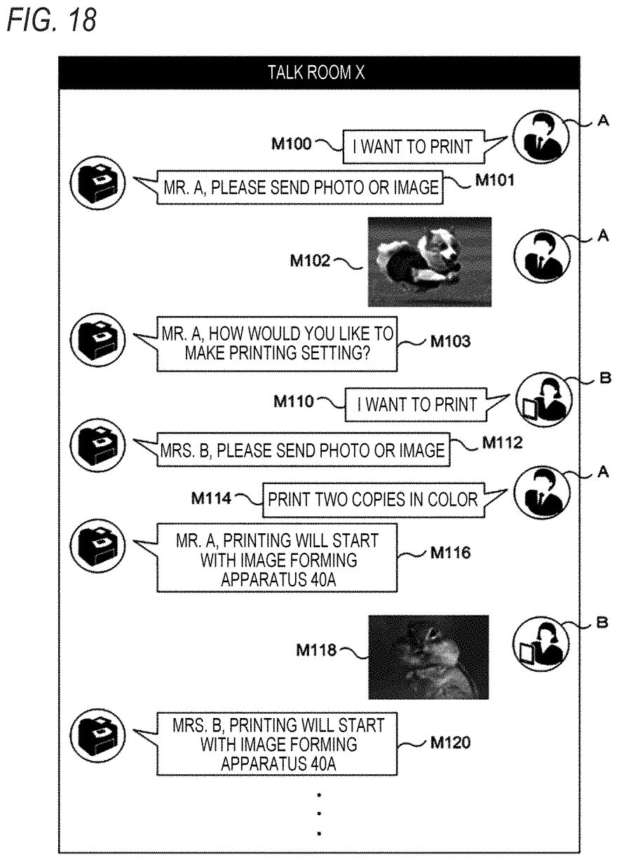

FIG. 18 is an example of a case where message information which is not appropriate to the process timing after the process P04 is posted.

As illustrated in FIG. 18, in the talk room, the CPU 31 posts the message information M103 indicating a request for a printing setting in response to the posting of the message information M102 (process P04). At the process timing after the process P04, the user B posts message information M110 related to a printing instruction. The CPU 31 analyzes the content of the message information M110, determines that the message information M110 is not message information for the process triggered by the message information M100 from the user A, and posts message information M112 indicating a request for posting of a file from the user B, as a new process (another process P02). In response to the posting of the message information M103, the user A posts message information M114 indicating the printing setting (process P05). In response to the posting of the message information M114, the CPU 31 posts message information M116 indicating the start of the printing (process P06). When message information M118 indicating a file including printing target data is posted by the user B in response to the message information M112, the CPU 31 posts message information M120 indicating the start of the printing in response to the posting of the message information M118 (another process P06).

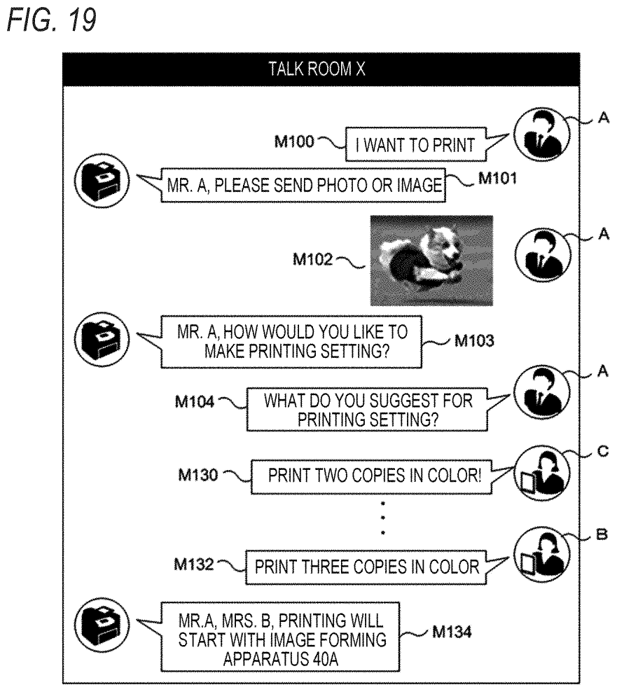

FIG. 19 is an example of treatment of message information from the user C having a different user characteristic from that of the user A who has instructed the printing, with respect to message information posted at the process timing after the process P04.

As illustrated in FIG. 19, in the talk room, the CPU 31 posts the message information M103 indicating a request for a printing setting in response to the posting of the message information M102 (process P04). At the process timing after the process P04, the user A posts the message information M104 inquiring the other users about the printing setting in response to the posting of the message information M103. In response to the message information M104 indicating the inquiry, the user C posts message information M130 indicating confirmation of the printing setting. The CPU 31 analyzes the posted message information M130, and determines that the posted message information M130 is appropriate in process timing. Meanwhile, the CPU 31 refers to the table illustrated in FIG. 7, and determines that the message information M130 is message information from the user C having a different user characteristic from that of the user A who has instructed the printing. Accordingly, the CPU 31 classifies the message information M130 into the case C3, for example, ignores the message information M130, and waits for a response to the message information M103. Next, the user B posts message information M132 indicating confirmation of the printing setting, and the CPU 31 determines that the posted message information M132 is message information related to the printing setting, and posts message information M134 indicating the start of the printing.

In the first exemplary embodiment, the descriptions have been made on the case where the user characteristic is determined by an image forming apparatus 40 associated with a user who participates in the talk room. In the present disclosure, the user characteristic is not limited to the image forming apparatus 40 associated with each user. For example, a user group in which plural users sharing a printing process are registered may be determined in advance, and the user group may be the user characteristic. In this case, an image forming apparatus 40 may be determined in units of the user group.

In the first exemplary embodiment, the image forming apparatus has been described as an example of the information processing apparatus 40. However, in the present disclosure, the information processing apparatus 40 is not limited to the image forming apparatus. Other examples of the information processing apparatus 40 include a communication device such as a mobile phone and a smart phone, an information processing device such as a computer, and an electronic device such as an air conditioner capable of, for example, setting a temperature or operating power on/off. The information processing apparatus 40 is not limited to an apparatus such as an electronic device. For example, the information processing apparatus 40 may be an information body that executes a service for implementing a predetermined function. An example of the information body may be an image conversion service for implementing an image conversion function which is executed on a cloud system.

### Second Exemplary Embodiment

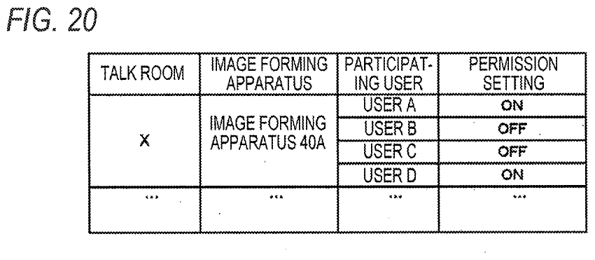

In a second exemplary embodiment, a table illustrated in FIG. 20 is used in placed of the table illustrated in FIG. 7.

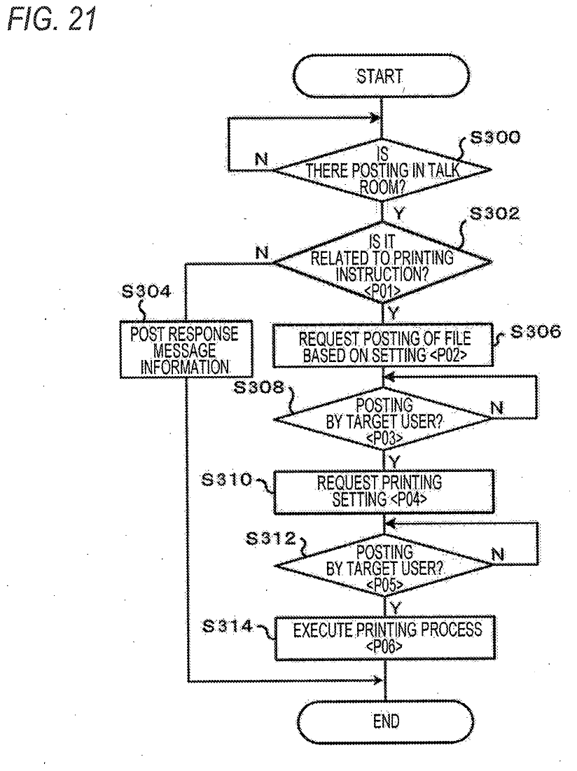

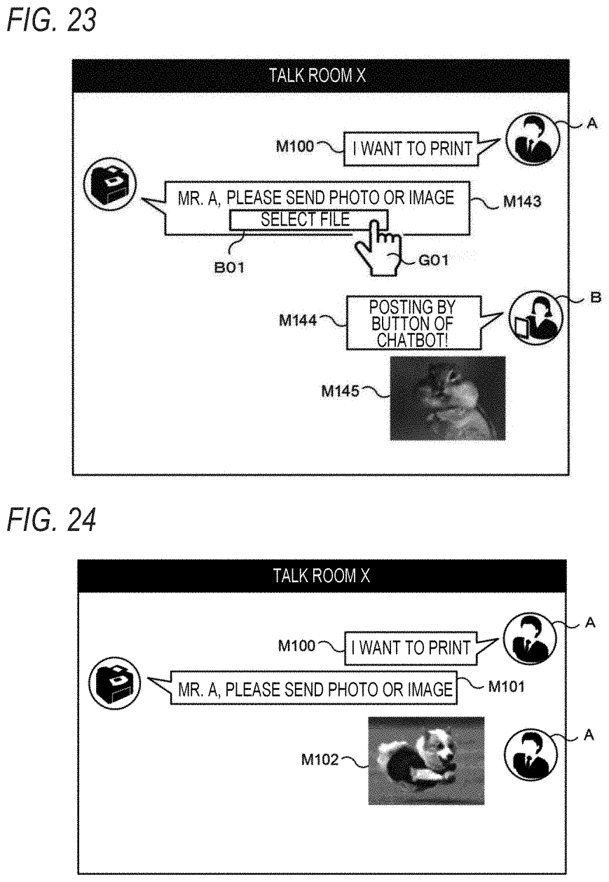

FIG. 21 is a flowchart of a control process by a chatbot server. The control process is performed by the CPU 31 reading a control program from the ROM 32 or the storage 34, and deploying and executing the control program on the RAM 33. FIGS. 23 to 25 are views illustrating states where postings are made in a talk room.

The CPU 31, as the execution controller 302, determines whether message information has been posted by a user in the talk room (step S300). When it is determined that no message information has been posted in the talk room (“No” in step S300), the CPU 31 waits until message information is posted. When it is determined that message information has been posted in the talk room (“Yes” in step S300), the CPU 31 determines whether the posted message information is message information related to a printing instruction (step S302). Here, the CPU 31 analyzes the posted message information by, for example, the natural language processing, and when the posted message information includes “print” or words related to a printing setting, the CPU 31 determines that the posted message information is message information related to a printing instruction.

When it is determined that the posted message information is not related to a printing instruction (“No” in step S302), the CPU 31 posts response message information which is appropriate to the posted message information, in the talk room (step S304). For example, when the user posts a message asking about the weather as message information, the CPU 31, as the chatbot, acquires weather information from the Internet and posts a message for answering the weather as response message information in the talk room. Accordingly, a conversation between the user and the chatbot is established in the talk room.

When it is determined that the posted message information is related to a printing instruction (“Yes” in S302), the CPU 31 posts message information indicating a request for posting of a file which is printing target data (step S306). Here, the CPU 31 posts (i) message information for requesting posting of a file only from the user who has instructed the printing or (ii) message information including permission indication information that indicates a permission to share information with another user, based on permission setting information predetermined for the user who has instructed the printing. That is, at the time of posting message information for expecting a response from a user, the CPU 31 selectively performs either (i) requesting the response only from the user or (ii) requesting the response from users including the user and another user, based on the permission setting information predetermined for the user. This process is a process including proceeding with the printing process while permitting plural users to make posts in response to message information posted by the CPU 31, and will be referred to as a permission process.

For example, when the user A posts the message information M100 indicating a printing instruction in the talk room (for example, FIG. 23), the CPU 31 refers to the table illustrated in FIG. 20 to acquire permission setting information “ON”, and executes the permission process of posting message information according to the permission setting information.

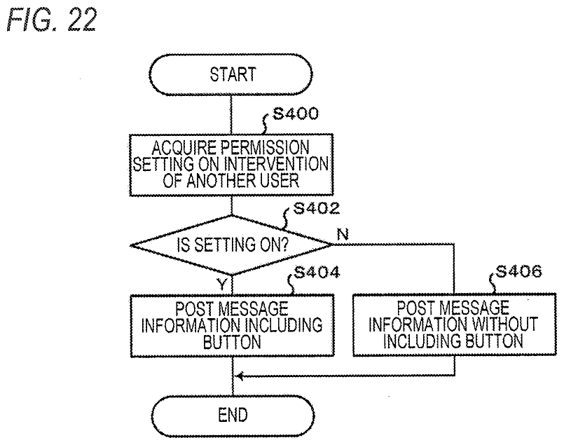

FIG. 22 is a flowchart of the permission process.

The CPU 31 refers to the table illustrated in FIG. 20, and acquires the permission setting information predetermined for the user who has instructed the printing (step S400). The permission setting information is information indicating whether to permit another user to intervene in the printing process of the user who has instructed the printing. When another user is permitted to intervene in the printing process, “ON” is set. When another user is not permitted to intervene in the printing process, “OFF” is set. When it is determined that the acquired permission setting information is ON (“Yes” in step S402), message information including an instruction button B01 is posted (step S404). For example, when the permission setting information for the user who has instructed the printing is set to “ON”, message information M143 including an instruction button B01 that indicates the permission indication information is posted in the talk room, as illustrated in FIG. 23. The instruction button B01 is a button that is displayed to be pressable by a user who is participating in the talk room. On the instruction button B01, a function which is performed in response to pressing (“select a file” in this example) is displayed. The example illustrated in FIG. 23 also displays an instruction figure G01 indicating that a user is pressing. Further, the example in FIG. 23 illustrates that posted are message information M144 indicating that the user B presses the instruction button B01 in response to the message information M143 and the user B makes a posting by pressing the button, and message information M145 indicating an image.

Meanwhile, when it is determined that the permission setting information is OFF (“No” in step S402), the CPU 31 posts only message information without including the instruction button B01 (step S406). For example, when the permission setting information for the user who has instructed the printing is set to OFF, message information M101 which does not include the instruction button B01 is posted in the talk room, as illustrated in FIG. 24. The example in FIG. 24 illustrates that the user A posts message information M102 indicating an image in response to the message information M101.

For example, in the example illustrated in FIG. 23, the message information M100 indicating the printing instruction by the user A may be posted by an input operation using a keyboard of the user terminal 10, or by pressing a posting button which is provided on the user terminal 10 or in the talk room for posting the message information M100. For example, in the example illustrated in FIG. 23, the message information M145 indicates an image and is posted by the user B pressing the instruction button B01. The message information M145 may be posted in such a manner that the user B selects posting of a file by pressing an instruction button such as a type of file posting and a place of the file posting, which is further displayed after the user B presses the instruction button B01. As for the instruction button which is further displayed after the pressing of the instruction button B01, an instruction button provided in advance in the talk room may be used.

As described above, when the message information M143 in which the instruction button B01 is displayed is posted, the printing process enters a state of being shared by the user A and another user according to the permission setting information preset for the user, so that any one of the users is able to post a photo or an image through the instruction button B01. Meanwhile, when the message information M101 in which the instruction button B01 is not displayed is posted, the printing process enters a state of being exclusive only for the user A, so that only the user A is able to post a photo or an image.

Next, the CPU 31 determines whether message information has been posted by a user in the talk room in response to step S306 (step S308). Here, the message information to be posted is message information indicating a file including printing target data. When it is determined that no message information has been posted in the talk room (“No” in step S308), the CPU 31 waits until message information is posted. When it is determined that message information has been posted in the talk room (“Yes” in step S308), the CPU 31 executes a process corresponding to the posted message information (step S310). This process is a process of posting message information for requesting a printing setting.

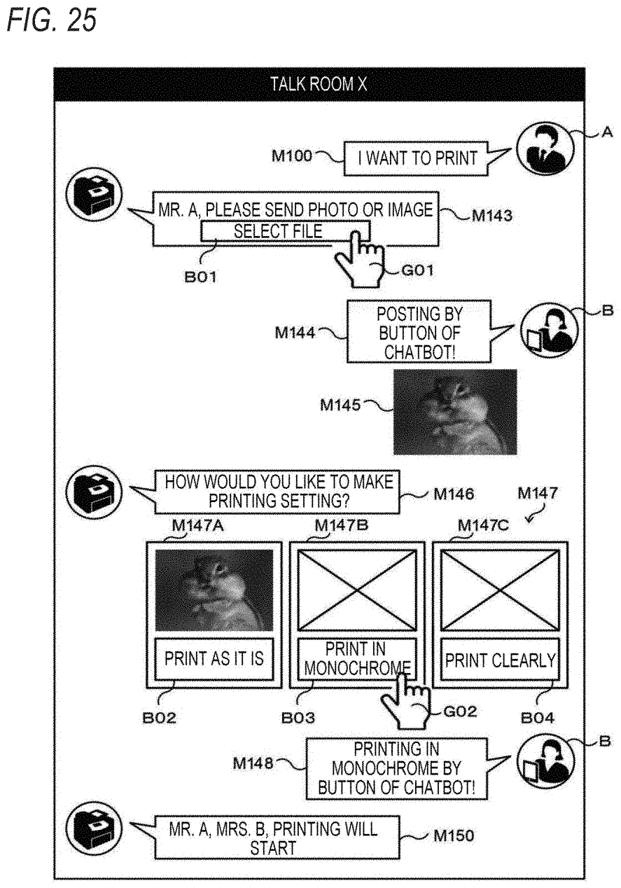

In addition to the message information for requesting the printing setting, the CPU 31 may provide information for allowing selection of one printing setting from among one or more printing settings. For example, in the talk room, as illustrated in FIG. 25, the CPU 31 posts message information M147 for allowing selection of one printing setting, after the message information M146 for requesting the printing setting is posted. In the example in FIG. 25, the message information M147 illustrates the case where plural printing settings are selectable by a so-called carousel function, that is, displaying one printing setting from among plural different printing setting, to be selectable. Message information M147A displays the posted image with the initial printing setting, and displays a “print as it is” button B02 that indicates printing using the initial printing setting, below the image. Message information M147B displays the posted image as a monochrome image, and displays a “print in monochrome” button B03 that indicates printing of a monochrome image, below the image. Message information M147C displays the posted image with an improved sharpness, and displays a “print clearly” button B03 that indicates printing with an improved sharpness, below the image.

The example illustrated in FIG. 25 also displays an instruction figure G02 indicating that a user is pressing. Further, the example illustrated in FIG. 25 displays message information M148 indicating that the user B makes posting by pressing a button when the user B presses the instruction button B03 in response to the message information M146.

Next, the CPU 31 determines whether message information has been posted by a user in the talk room in response to step S310 (step S312). Here, the message information to be posted is message information indicating a printing setting designated by a user. When it is determined that no message information has been posted in the talk room (“No” in step S312), the CPU 31 waits until message information is posted. When it is determined that message information has been posted in the talk room (“Yes” in step S312), the CPU 31 executes a process corresponding to the posted message information (step S314). This process is a process of posting message information indicating the start of the printing according to the printing setting.

The control system according to the second exemplary embodiment has been described. However, the present disclosure is not limited to the exemplary embodiments described above. The present disclosure may be modified or improved in various ways. Hereinafter, examples of the modification or improvement will be described as modifications.

### Modification 1

In the second exemplary embodiment, the descriptions have been made on the case where the permission setting information is associated in advance with a user who is participating in the talk room. However, the permission setting information may be dynamically set based on message information in the talk room.

In Modification 1, the CPU 31 of the chatbot server 30, as the chatbot, may set the permission setting information for a user based on message information posted by the user when the user joins the talk room. That is, the chatbot server 30 executes a setting process of setting the permission setting information as to whether to permit message information to be shared with the other user in the talk room, to either ON or OFF, based on message information posted by the respective users.

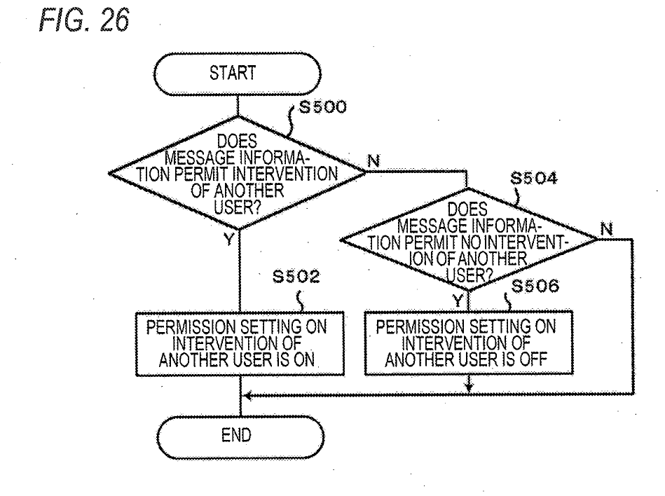

FIG. 26 is a flowchart of the setting process executed by the chatbot server. The CPU 31 reads a setting program from the ROM 32 or the storage 34, and deploys and executes the program in the RAM 33. The setting process illustrated in FIG. 26 is executed when message information is posted by a user.

When message information is posted by a user in the talk room, the CPU 31 determines whether the content of the posted message information is a sharing permission message that indicates permitting an intervention by the other users in the talk room to share information with the other users (step S500). For example, the CPU 31 analyzes the posted message information by, for example, the natural language processing, and determines that the posted message information is the sharing permission message, when the posted message information includes words indicating sharing of information with the other users in the talk room, such as “shared printing” or “common printing”. When it is determined that the posted message information is the sharing permission message (“Yes” in step S500), the CPU 31 sets the setting permission information to ON (step S502). When it is determined that the content of the posted message information does not include the content that permits the intervention by the other users (“No” in step S500), the CPU 31 determines whether the content of the posted message information is a private permission message including the content indicating that do not permit the intervention by the other user (step S504). For example, the CPU 31 analyzes the posted message information by, for example, the natural language processing, and determines that the posted message information is the private permission message, when the posted message information includes words such as “private printing” and “exclusive printing” that indicate privately executing the printing without sharing information with the other users in the talk room. When it is determined that the posted message information is the private permission message (“Yes” in step S504), the CPU 31 sets the setting permission information to OFF (step S506).

On the other hand, when it is determined that the content of the posted message information is neither the sharing permission message nor the private permission message (“No” in each of steps S500 and S504), the posted message information is estimated as another message information which is not related to the setting of the permission setting information, and thus, the present process routine ends.

In addition, the permission setting information set by the setting process illustrated in FIG. 26 may be a temporary setting only during the printing process, or the permission setting information of the table illustrated in FIG. 20 may be rewritten.

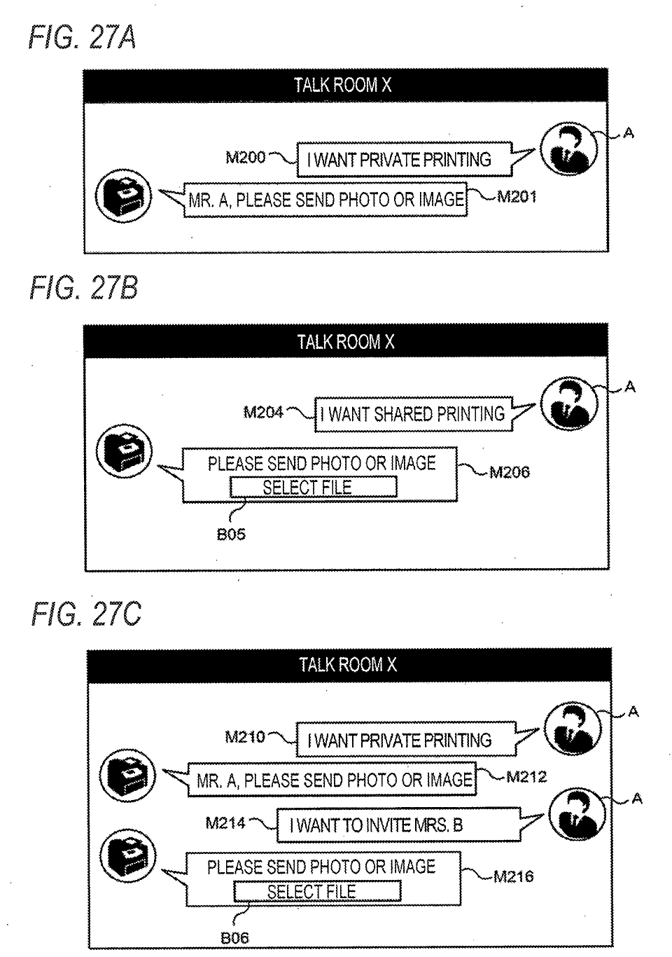

FIGS. 27A to 27C are views illustrating other examples of the state where postings are made in the talk room according to Modification 1. FIGS. 27A and 27B illustrate examples of a case where the permission or non-permission of the intervention of another user is declared at the time when the printing process is instructed by a user. FIG. 27A illustrates a case of non-sharing which does not permit the other users to intervene in the printing process. FIG. 27B illustrates a case of sharing which permits the other users to intervene in the printing process. FIG. 27C illustrates a case of sharing in which the intervention of other users is permitted in the middle of the printing process.

As illustrated in FIG. 27A, when message information M200 of “I want private printing” is posted by the user A, the CPU 31 determines that the message information M200 is the private permission message, and thus, posts message information M201 indicating a request only to the user A. As illustrated in FIG. 27B, when message information M204 of “I want shared printing” is posted by the user A, the CPU 31 determines that the message information M204 is the sharing permission message, and thus, posts message information M206 including an instruction button B05. The instruction button B05 is a button displayed to be pressable by users who are participating in the talk room, and indicates the permission of the intervention of the other users.

As illustrated in FIG. 27C, when message information M212 is posted in response to message information M210, and then, message information M214 of “I want participation of Mrs. B” is posted by the user A during the execution of the printing process, the CPU 31 determines that the message information M214 is the sharing permission message, and thus, posts message information M216 including an instruction button B06.

### Modification 2

Next, Modification 2 will be described.

In the exemplary embodiments described above, when another user is permitted to intervene in the printing process, message information accompanying an instruction button is posted, so that when the instruction button is pressed, message information from another user is received. However, the present disclosure is not limited to the pressing of the instruction button. An instruction button may be regarded as having been pressed, based on message information in the talk room.

In Modification 2, when the CPU 31 of the chatbot server 30 posts message information including an instruction button, the CPU 31 of the chatbot server 30 may acquire object information from message information posted via the pressing of the instruction button and the posted message information. That is, the chatbot server 30 executes an acquisition process of acquiring the object information which is acquired as a response to the message information posted including the instruction button, from the message information posted via the pressing of the instruction button or the posted message information.

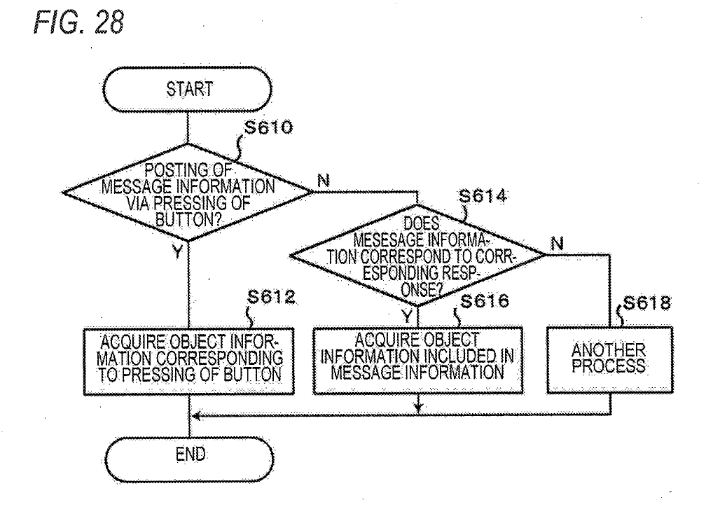

FIG. 28 is a flowchart of the acquisition process executed by the chatbot server. The CPU 31 reads a setting program from the ROM 32 or the storage 34, and deploys and executes the program in the RAM 33. The acquisition process illustrated in FIG. 28 is executed after the message information including the instruction button is posted.

When message information including an instruction button is posted, the CPU 31 determines whether message information posted in response is message information posted via the pressing of the instruction button (step S610). When it is determined that the posted message information is message information posted via the pressing of the instruction button (“Yes” in step S610), the CPU 31 acquires the message information posted via the pressing of the instruction button as object information (step S612). When it is determined that the posted message information is message information directly posted without the pressing of the instruction button (“No” in step S610), the CPU 31 determines whether the content of the posted message information is message information that corresponds to the corresponding response (step S614). For example, when the corresponding response is posting of a file such as a photo or an image, the CPU 31 determines whether the posted message information is posting of a file. When it is determined that the content of the posted message information is message information that corresponds to the corresponding response (“Yes” in step S614), the CPU 31 acquires the posted message information as object information (step S616).

On the other hand, when it is determined that the posted message information does not correspond to the corresponding response (“No” in step S614), the posted message information is likely to be message information of another printing process. Thus, another process is performed (step S618), and then, the present process routine ends.

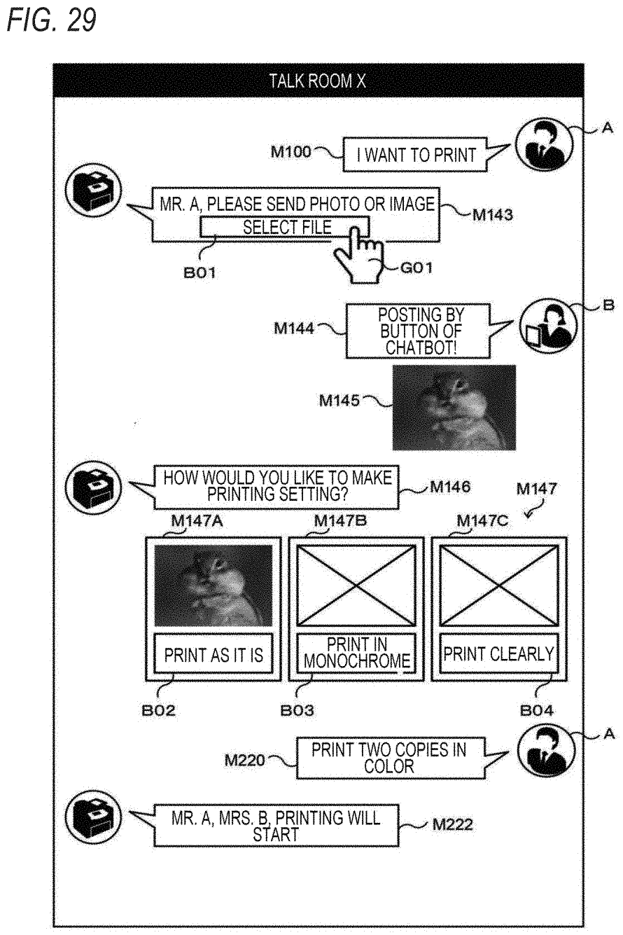

FIG. 29 is a view illustrating a state where postings are made in the talk room according to Modification 2.

For example, in the talk room, as illustrated in FIG. 29, the CPU 31 posts the message information M146 for requesting a printing setting, and then, posts the message information M147 for allowing selection of one printing setting.

The example in FIG. 29 illustrates a case where although any one of the instruction buttons B02, B03, and B04 included in the message information M147 is pressable by the user as a response to the message information M146, the user A posts message information M220 indicating an instruction of a printing setting without pressing an instruction button. Accordingly, instead of information acquired via the pressing of the instruction button included in the message information M147, it is regarded that an instruction button has been pressed, and object information indicating a response to the message information M146 may be acquired from the content of the posted message information M220.

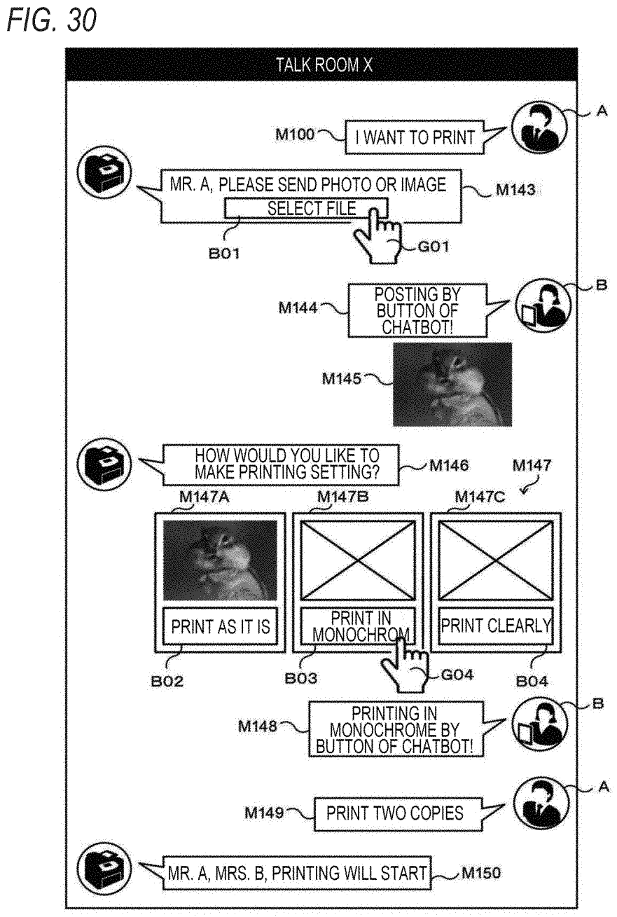

When it is regarded that an instruction button has been pressed, and object information is acquired from the content of the posted message information M220, it is possible to further add information to the information acquired from the pressing of an instruction button. For example, as illustrated in FIG. 30, in response to the message information M146, the instruction button B03 is pressed by the user B so that the message information M148 indicating the printing setting is posted by the user B, and then, message information M149 indicating an additional printing setting is posted by the user A.

### Modification 3

Next, Modification 3 will be described.

In the exemplary embodiments, the descriptions have been made on the case where message information accompanying an instruction button is posted when the intervention of other users in the printing process is permitted. However, the timing for permitting the intervention of other users in the printing process may be a timing when a user presses the instruction button. That is, the user may be asked to confirm whether to permit other users to intervene in the printing process.

In Modification 3, the CPU 31 of the chatbot server 30 may cause a user to confirm whether to permit other users to intervene in the printing process with respect to message information posted by another user, and acquire message information according to a result of the confirmation in order to cause the other users to intervene in the printing process. That is, the chatbot server 30 executes a confirmation process of causing a user to confirm whether to permit, with respect to message information posted via the pressing of an instruction button.

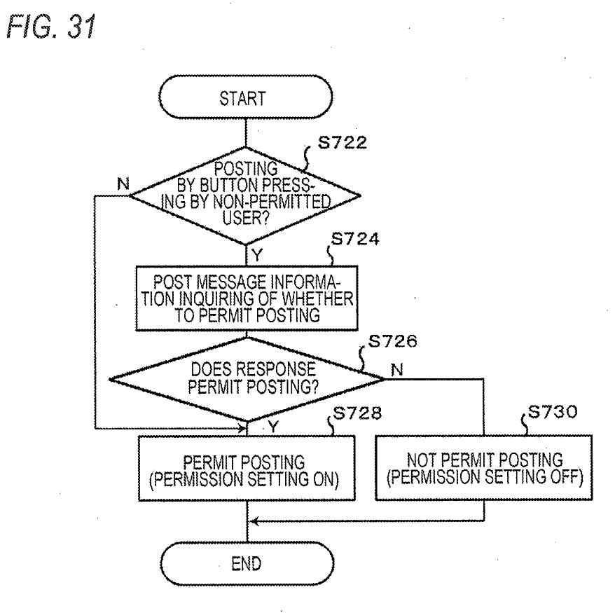

FIG. 31 is a flowchart of the confirmation process executed by the chatbot server. The CPU 31 reads a setting program from the ROM 32 or the storage 34, and deploys and executes the program in the RAM 33. The confirmation process illustrated in FIG. 31 is executed after the message information including the instruction button is posted. In Modification 3, descriptions will be made on a case where the CPU 31 posts message information including an instruction button and directed to the user A who has instructed the printing. Also, descriptions will be made on a case where the permission setting information of the user A is OFF. Furthermore, it is assumed that the instruction button is pressable by each participating user.

When posting message information including an instruction button, the CPU 31 determines whether message information posted in response is message information posted by a user other than the user A pressing the instruction button (step S722). When message information is posted by the user A (“No” in step S722), the CPU 31 permits the posting of the message information. When message information is posted by another user other than the user A (“Yes” in step S722), the CPU 31 posts message information for inquiring the user A whether to permit the posting (step S724). The CPU 31 determines whether message information by the user A in response to the inquiry includes the contents that permit the posting by another user (step S726). When message information including the content that permits the posting is posted from the user A (“Yes” in step S726), the CPU 31 permits the posted message information (step S728). When message information including the content that does not permit the posting is posted from the user A (“No” in step S726), the CPU 31 does not permit the posted message information (step S730).

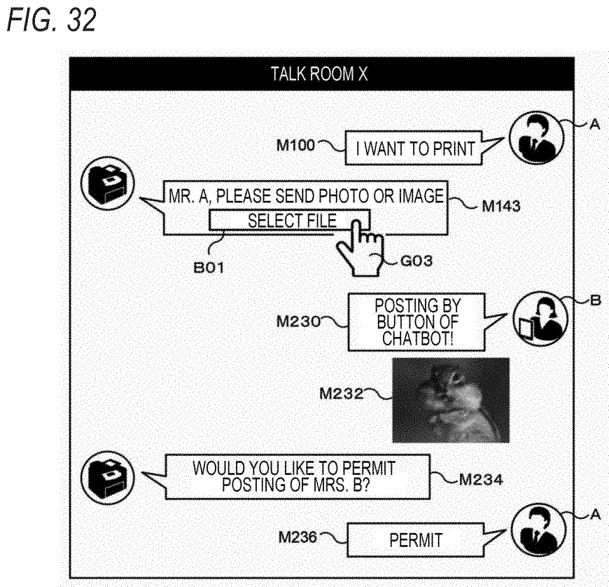

FIG. 32 is a view illustrating a state where postings are made in the talk room according to Modification 3.

For example, in the talk room, as illustrated in FIG. 32, the CPU 31 posts message information M103 for requesting a photo or an image, and then, posts message information M107 for allowing selection of one printing setting.

For example, in the talk room, as illustrated in FIG. 32, message information M143 including an instruction button B01 is posted. The instruction button B01 is an instruction button that is displayed so as to be pressable by a user who is participating in the talk room. As illustrated in FIG. 32, an instruction figure G03 indicating that the user B other than the user A is pressing is also displayed. As illustrated in FIG. 32, message information M230 indicating that the user B presses the instruction button B01 in response to the message information M143 and the user B makes a posting by pressing the button, and message information M232 indicating an image are posted. At this stage, the posting of the message information M232 indicating an image is neither a permitted posting nor a non-permitted posting, and is undefined.

The CPU 31 posts message information M234 for inquiring the user A whether to permit the posted message information M230 and M232. Based on the content of the message information M236 posted by the user A in response to the message information M234, the CPU 31 determines to permit the message information M230 and M232 posted by the user B.

When the posting is permitted in step S728, the CPU 31 may set the permission setting information to ON, and when the posting is not permitted in step S730, the CPU 31 may set the permission setting information to OFF.

In the first and second exemplary embodiments, the descriptions have been made on the case where the present disclosure is applied to the control system for providing the talk room. However, the present disclosure is not limited to the talk room. For example, the present disclosure may be applied to a system for executing a predetermined function to be implemented. An example of such a system is a system for performing a process on an object such as a system for reserving, for example, a product, or a system for delivering, for example, a product.

In the first and second exemplary embodiments, the case where the talk room server 20 and the chatbot server 30 are different devices has been described as an example. However, the talk room server 20 and the chatbot server 30 may be implemented by a single device.

The processes described above may be implemented by a dedicated hardware circuit. In this case, the processes may be executed by a single hardware component or plural hardware components.

In addition, the program for operating the chatbot server 30 may be provided by a computer readable recording medium such as a universal serial bus (USB) memory, a flexible disc, or a compact disc read only memory (CD-ROM), or provided online through a network such as the Internet. In this case, the program recorded in the computer readable recording medium is usually transmitted to and stored in, for example, a memory or storage. In addition, the program may be provided as, for example, single application software or equipped as one function of the chatbot server 30 in the software of each corresponding device.

While the exemplary embodiments of the present disclosure have been described, the technical scope of the present disclosure is not limited to the scope described in the exemplary embodiments. The exemplary embodiments may be modified or improved in various ways within the scope that does not deviate from the gist of the present disclosure, and the corresponding modification and improvement are also included in the technical scope of the present disclosure.

The foregoing description of the exemplary embodiments of the present disclosure has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control apparatus comprising:
a processor, wherein
in a talk room, each of a plurality of participating users among a plurality of users registered for each user group is able to post information, and
the processor is configured, when in the talk room, during an execution of a specific process, a second user who has been registered in a user group in which a first user is registered posts second information after the first user posts first information among a series of information related to the specific process, to process the second information as the series of information.

2. A control apparatus comprising:
a processor, wherein
in a talk room, each of a plurality of participating users is able to post information,
the processor is configured, when in the talk room, during an execution of a specific process, second information appropriate to the content of first information is posted after the first information among a series of information related to the specific process is posted, to process the second information as the series of information.

3. The control apparatus according to claim 1, wherein the processor ignores third information posted by a third user who has not been registered in the user group in which the first user is registered.

4. The control apparatus according to claim 1, wherein the processor processes third information posted by a third user who has not been registered in the user group in which the first user is registered, as posting of information related to another specific process different from the specific process.

5. The control apparatus according to claim 1, wherein when the second information which is appropriate to the content of the first information is posted, the processor processes the second information as the series of information.

6. The control apparatus according to claim 2, wherein when the content of the second information is not appropriate to the content of the first information, the processor ignores the second information.

7. The control apparatus according to claim 2, wherein when the content of the second information is not appropriate to the content of the first information, the processor processes the second information as posting of information related to another specific process different from the specific process.

8. A non-transitory computer readable medium storing a program causing a computer to execute a control process,
wherein in a talk room, each of a plurality of participating users among a plurality of users registered for each user group is able to post information,
the control process comprising:
when in the talk room, during an execution of a specific process, a second user who has been registered in a user group in which a first user is registered posts second information after the first user posts first information among a series of information related to the specific process, making the second information the series of information.

9. A non-transitory computer readable medium storing a control program causing a computer to execute a control process,
wherein in a talk room, each of a plurality of participating users is able to post information,
the control process comprising:
when in the talk room, during an execution of a specific process, second information appropriate to the content of first information is posted after the first information among a series of information related to the specific process is posted, making the second information the series of information.

10. A control apparatus comprising:
a processor, wherein
in a talk room, each of a plurality of participating users is able to provide information, and
the processor is configured, when in the talk room, during an execution of a specific process, a second user different from a first user provides second information after the first user provides first information among a series of information related to the specific process, to process the second information as information provided from the first user who provides the first information, based on a predetermined permission condition for receiving as the series of information.

11. The control apparatus according to claim 10, wherein
in the talk room, each of a plurality of users registered for each user group is able to provide information, and
the permission condition includes a condition that the second user is a user included in a user group in which the first user who provides the first information is registered.

12. The control apparatus according to claim 10, wherein the permission condition includes a condition that permission information indicating that information provided from the second user who is different from the first user is permitted as the series of information was provided in the talk room.

13. The control apparatus according to claim 10, wherein the permission condition includes a condition that (i) instruction information indicating that an instruction to permit information provided from a user different from the first user as the series of information is presented and (ii) the second user is a user who responds to the instruction information.

14. The control apparatus according to claim 13, wherein the instruction information is information indicating a button for providing information indicating a response in response to an operation of any one of a plurality of users.
